(19) United States
(12) Patent Application Publication
(10) Pub. No.: US 2007/0002007 A1
(43) Pub. Date: Jan. 4, 2007

(54) Electro-optical arrangement

(75) Inventor: Simon Tam, Cambridge (GB)

Correspondence Address: OLIFF & BERRIDGE, PLC, P.O. BOX 19928, ALEXANDRIA, VA, 22320, US

(73) Assignees: SEIKO EPSON CORPORATION, Tokyo (JP); NTERA LIMITED, County Dublin (IE)

(21) Appl. No.: 11/473,121

(22) Filed: Jun. 23, 2006

(30) Foreign Application Priority Data
Jul. 4, 2005 (EP) 05254195.0

(51) Int. Cl. G09G 3/38

(52) U.S. Cl. 345/105

(57) ABSTRACT

An electro-optical arrangement includes an electrochromic device which can take either a cleared (transparent) state, a first display state or a second display state, and a driving stage which provides first and second electrode-drive signals to drive the first and second electrodes of the device. At least one of the electrode-drive signals is supplied by way of a polysilicon thin-film buffer. The driving stage in an initial clearing operation outputs approximately equal voltages to the electrodes, which places the device into its transparent state. Subsequently the driver stage applies voltages to the electrodes, such that the device assumes either the first display state or the second display state. In either state it is arranged for the device not to be subjected to more than a safe operating voltage. Preferably, in one of the electrochromic device's two display states one of its electrodes is supplied with a voltage which is higher than the voltage (Vcom) on the other electrode, while in the other of its two display states the one electrode is supplied with a voltage which is lower than the voltage (Vcom) on the other electrode, the two voltage differences being less than the safe operating voltage. The second display state may itself be a transparent state, while the first display state may be a colored state. Alternatively, the two states may be differently colored states.

### TECHNICAL FIELD

The invention relates to an electro-optical arrangement including an electrochromic device. The invention in a second aspect thereof also relates to a method of driving an electrochromic device.

### BACKGROUND ART

Electrochromic devices (ECDs) are known, which undergo a reversible color change of a material when an electric current or voltage is applied to the device. This phenomenon is known as electrochromism. A typical ECD consists of two conductors sandwiching a combination of an electrochromic material and an electrolyte.

There are three types of ECD: the intercalation type, the solution-based type and the nanostructure type. The principle of the intercalation type is shown in FIG. 1(a). The electrodes take the form of transparent electrodes 12, 13 on respective glass substrates 10, 11, the electrodes being covered with an organic or inorganic polymer 14, 15. The two materials normally display complementary electrochromism and hence produce the same color change when one is oxidized while the other is reduced. Once the color change has taken place, the state of the device remains even in the absence of an applied voltage. Thus the device can be termed a non-volatile device. This type of ECD, however, is slow to change color due to the low migration rate of the counter-ions in the bulk polymer. It is also difficult to obtain strong color changes or bright colors.

In the second type, illustrated in FIG. 1(b), two complementary electrochromic molecules are dissolved in a solvent. Species A and A+ are in different color states. Upon application of a negative voltage, as shown, species A becomes A+. Electrons are transferred to species B in the electrolyte to form B− ions, which then migrate towards the positive terminal. When power is disconnected, A+ and B+ leave the electrode readily and reverse charge transfer takes place. This type of system is very simple to construct, reacts very quickly and can produce dark or bright colors. It has the drawback, however, that an electric current is needed to maintain the colored state, because the two types of colored molecules diffuse through the system and react with each other to restore the bleached (clear) states. Consequently it cannot be used for large-area devices or for battery-powered displays, since energy consumption is high.

The third, nanostructure type of ECD exhibits non-volatility and is capable of rapid color change. This is achieved by attaching a suitable molecule, that is colorless in the oxidized state and colored in the reduced state, onto the surface of a monolayer of colorless semiconductor on a transparent electrode formed on glass. When a sufficiently negative potential is applied at one electrode, with the other electrode held at ground potential, electrons are injected into the conduction band of the semiconductor and reduce the adsorbed molecules (the coloration process). The reverse process occurs when a positive potential is applied at the electrode and the molecules become bleached (transparent). This arrangement is shown in FIG. 1(c). In this figure species A and A+ are in different color states. Upon application of a negative voltage, as shown, species A (which may in practice be a viologen), which is adsorbed within the nanostructure, becomes A+. Electrons are transferred to species B in the electrolyte to form B− ions, which then migrate towards the positive terminal. When power supply is disconnected, it takes a long time for B− ions to reach A+ before a reverse charge transfer can take place. Indeed, it is common for such devices to retain their color change for the order of days.

This system combines the immobility of the electrochromic material with the rapidity and coloration efficiency of molecular systems. Because a single molecular monolayer does not absorb a perceptible amount of light, nanocrystalline semiconductor films are used to promote the light absorption property of the molecular monolayer to visible color changes. The nanocrystalline layer is highly porous to encourage more molecular monolayer to be present. As light passes through the layer, it crosses several hundreds of monolayers of colored molecules, giving a strong absorption.

Electrochromic devices have many applications, including use as electronic books and newspapers, large-area displays, price labels in stores, etc. A particular advantage they have over other technologies is the retention of a large contrast ratio over widely varying viewing angles. The contrast ratio is very significantly better than, say, that of print on paper (conventional newspapers or books).

An electrochromic display, to which the present invention may be applied, consists of a plurality of nanostructure-type electrochromic cells having non-volatile charge-storage states with preferred polarity and voltage. Such displays may be driven by any of three well-known methods, namely direct driving, passive matrix driving and active matrix driving.

An example of direct driving is shown in FIG. 2, in which the segments of a seven-segment display 20 are driven directly by dedicated drivers in a controller stage 22. To briefly describe the driving procedure, first of all the display is cleared to a transparent state by connecting the top electrodes to a common bottom electrode, a process called “bleaching”. Then, a positive voltage is applied through the controller to those electrodes that are required to be colored. The controller can then be separated from the display through isolating switches 24. This scheme is simple to design and can be driven by a controller constructed with discrete components. However, because the number of interconnections increases with the number of electrodes, this driving method is inefficient and is not suitable for the display of high-resolution images.

A passive matrix driving scheme is shown in FIG. 3. The passive matrix driving method is different for an electrochromic display than for a liquid crystal display (LCD), though the display structures are similar. In an LCD, such as that described in U.S. Pat. No. 4,626,841, a passive matrix pixel is addressed when there is a sufficient voltage across it to cause the liquid crystal molecules to align parallel to the electric field. A display can have more than one pixel on at any one time because of the response time of the liquid crystal material. When addressed, a pixel has a short turn-on time during which the liquid crystal molecules align in such a way as to make the pixel opaque. When the voltage is removed, the pixel behaves like a discharging capacitor, slowly turning off as charge dissipates and the molecules return to their undeformed orientation. Because of this response time, a display can scan across the matrix of pixels, turning on the appropriate ones to form an image. As long as the time to scan the entire matrix is shorter than the turn-off time, a multiple pixel image can be displayed.

In an electrochromic display, on the other hand, each pixel can be considered as a rechargeable battery whose charging state results in a pixel color intensity (opaque when fully charged, clear when discharged). Referring to FIG. 3, the entire display is first cleared by applying the same voltage to all electrodes acting as the address lines and data lines (see FIG. 3(a)). Then (see FIG. 3(b)) all the address lines are disconnected (i.e. they are allowed to float) except for the one line to be addressed, to which a voltage V+ is applied. Data voltages are applied at the data lines in the following fashion. Similarly to the direct-drive method, a voltage V− is applied to the data lines connected to pixels that are to show color. The data lines connected to pixels which are to remain clear are disconnected from the power source, i.e. they are allowed to float. “V+” and “V−” indicate the polarity of the pixel cells, V+ being greater than V−. Then (FIG. 3(c)), the selected address line is disconnected and the next address line is connected to V+ and data voltages are applied to selected data lines, and so on.

The disadvantage of passive matrix driving is the disturbance of charge stored at each cell by subsequent data variation on the data lines. Image diffusion due to leakage through the electrolyte and crosstalk caused by interaction between pixels via the shared electrodes are additional problems. Some of these problems have been addressed by U.S. Pat. No 4,129,861 by inserting diode elements to increase the threshold voltage of each electrochromic device.

An example of an active matrix driving scheme disclosed in U.S. Pat. No. 5,049,868 is shown in FIG. 4. This patent suggests the use of thin-film transistors (TFTs) to isolate the electrochromic devices in an active matrix display. The devices comprise an output electrode 47 each and a common electrode 48. Between the two electrodes is the ECD electrolyte 49. The data line 40 is gated by two select transistors 41 connected in series. The gates of these selected transistors are connected to the row lines 42 and column lines 43. Once the pixel has been selected, the data voltage (high or low) is passed to the gate of the driver transistor 44, which is capable of passing a high current to the electrochromic device, and is stored by a capacitor 45. This gate voltage can turn the driver transistor 44 on or off. An optional isolation transistor is provided at the output line 46 in order to isolate the driver transistor from the output electrode 47.

### SUMMARY OF THE INVENTION

In accordance with a first aspect of the invention there is provided an electro-optical arrangement, comprising: an electrochromic device capable of being selectively placed into a first display state and a second display state, the device having first and second electrodes and a predetermined safe operating voltage value, V_{safe}, of a voltage to be applied across the first and second electrodes; and a driver stage for providing a first electrode-drive signal to drive said first electrode and a second electrode-drive signal to drive said second electrode, the driver stage comprising a polysilicon thin-film transistor buffer for receiving a drive signal from an external controller and for supplying this drive signal as a buffered second electrode-drive signal to the electrochromic device, the driver stage being configured such that, to drive the device into its first display state, it applies as the first electrode-drive signal a first voltage V₁ and as the second electrode-drive signal a second voltage V₂, and to drive the device into its second display state, it applies as the first electrode-drive signal a third voltage V₃ and as the second electrode-drive signal a fourth voltage V₄, wherein:
V₂>V₁
V₃>V₄
|V₁-V₂|≦V_{safe}, and
|V₃-V₄|≦V_{safe}

The voltages V₁ and V₃ may advantageously be equal to each other.

The arrangement may comprise a two-dimensional array of the electro-optical devices, the buffer comprising a plurality of polysilicon thin-film transistor drive elements, one for each of the electrochromic devices in a row, and wherein the driver stage comprises a shift register and a latch interposed between the external controller and the buffer stage, whereby drive signals (Vdata) from the external controller for a row of the electrochromic devices can be serially loaded into the shift register, latched and passed on as the second electrode-drive signals (Vdat) to a row of electro-optical devices by way of the buffer.

The relationship between the first, second, third and fourth voltages may be that
V₁=V₃≈½(V₂−V₄)

The driver stage may be configured such that, while the latched drive signals (Vdata) are being applied to one row of the array, the drive signals (Vdata) for the next row are loaded into the shift register. This has the advantage that time is saved in achieving charging of the ECD device or devices.

The buffer may be arranged to provide a constant-current output and the driver stage may be arranged to write data signals to the electrochromic devices in a series of successive write operations, the intensity of coloration in selected ones of the electrochromic devices being changed successively in one or more of the write operations until the desired coloration intensity for each of the selected electrochromic devices is achieved. This measure allows a greyscale to be achieved, the number of write operations corresponding to the number of bits of the greyscale.

The successive write operations may be arranged to achieve different additional coloration intensities. These additional coloration intensities may increase or decrease in a binary series.

The second electrode-drive signal, during frames in which there is to be no increase in coloration intensity, may assume a floating state. Alternatively, the second electrode-drive signal, during frames in which there is to be no increase in coloration intensity, may assume a second voltage value V₂ which is lower than the second voltage value V₂ which would be assumed during frames in which there was to be an increase in coloration intensity.

The safe voltage value, V_{safe}, may be approximately 1.4V, the second voltage, V₂, approximately 2.5V maximum, the fourth voltage, V₄, approximately 0V and the first voltage, V₁, and the third voltage, V₃, approximately 1.25V maximum.

The driver stage may be configured to apply, before the application of the first, second, third and fourth voltages, V₁-V₄, fifth and sixth voltages, V₅ and V₆, to the first and second electrodes, respectively, in order to place the electrochromic device into an initial clear state, wherein V5≈V6. In practice, V5 may equal V6.

The first display state may be a first coloration state, in which the electrochromic device displays a first color, and the second display state may be a second coloration state, in which the electrochromic device displays a second color. Alternatively, the first display state may be a coloration state, in which the electrochromic device displays a given color, and the second display state may be a clear state, in which the electrochromic device is transparent.

In a second aspect of the present invention a method is provided for driving an electrochromic device capable of being selectively placed into a first display state and a second display state, the device having first and second electrodes and a predetermined safe operating voltage value, V_{safe}, of a voltage to be applied across the first and second electrodes, the method comprising applying a first voltage less than the safe operating voltage across the first and second electrodes in one direction to place the device into the first display state, or applying a second voltage less than the safe operating voltage across the first and second electrodes in the opposite direction to place the device into the second display state, the first and/or second voltage being applied by way of a polysilicon thin-film transistor buffer.

The first display state may be a cleared state. The first voltage may be approximately zero volts.

The electrochromic device may be one of a plurality of such electrochromic devices arranged in a two-dimensional array, and drive signals (Vdata) for the electrodes of a row of the electrochromic devices may be serially loaded into a shift register, latched and then passed on by way of the polysilicon thin-film transistor buffer to the row of electro-optical devices. While the latched drive signals (Vdata) are being applied to one row of the array, the drive signals (Vdata) for the next row may be loaded into the shift register.

The buffer may be arranged to provide a constant current output and the driver stage may write data signals to the electro-optical devices in a series of successive write operations, the intensity of coloration in selected ones of the electrochromic devices being changed successively in one or more of the write operations until the desired coloration intensity for each of the selected electrochromic devices is achieved.

The successive write operations may achieve different additional coloration intensities. Furthermore the successive write operations may achieve additional coloration intensities which increase or decrease in a binary series.

The buffer may apply a voltage (Vdat) of a first value to the first electrode to achieve the first display state or apply a voltage (Vdat) of a second value to the first electrode to achieve the second display state, and a voltage of a third value intermediate the first and second voltage values may be applied to the second electrode. The third voltage value may lie approximately midway between the first and second voltage values.

The buffer may comprise a plurality of polysilicon thin-film transistor stages for respective electrochromic devices in a row, the thin-film transistor stages being associated with a threshold-voltage value for those stages, and wherein said second voltage value is higher than said first voltage value by said threshold-voltage value.

The first and second display states may be first and second coloration states, respectively, in which the electrochromic device displays different colors.

### BRIEF DESCRIPTION OF THE DRAWINGS

Embodiments of the invention will now be described in detail, purely by way of example, with reference to the drawings, of which:

FIGS. 1(a), 1(b) and 1(c) are schematic diagrams of three known forms of electrochromic device;

FIGS. 2 and 3 are schematic diagrams showing the known direct and passive-matrix driving schemes, respectively;

FIG. 4 is a schematic diagram of an active-matrix driving arrangement for an ECD;

FIG. 5 is a schematic diagram of an embodiment of an electro-optical arrangement in accordance with the present invention;

FIGS. 6 and 7 are waveform diagrams of an active-matrix driving method under an aspect of the present invention;

FIG. 8 is a waveform diagram similar to that of FIG. 7, but adapted for quicker charging of the ECDs, and

FIG. 9 is a greyscale version of the electro-optical arrangement according to the present invention.

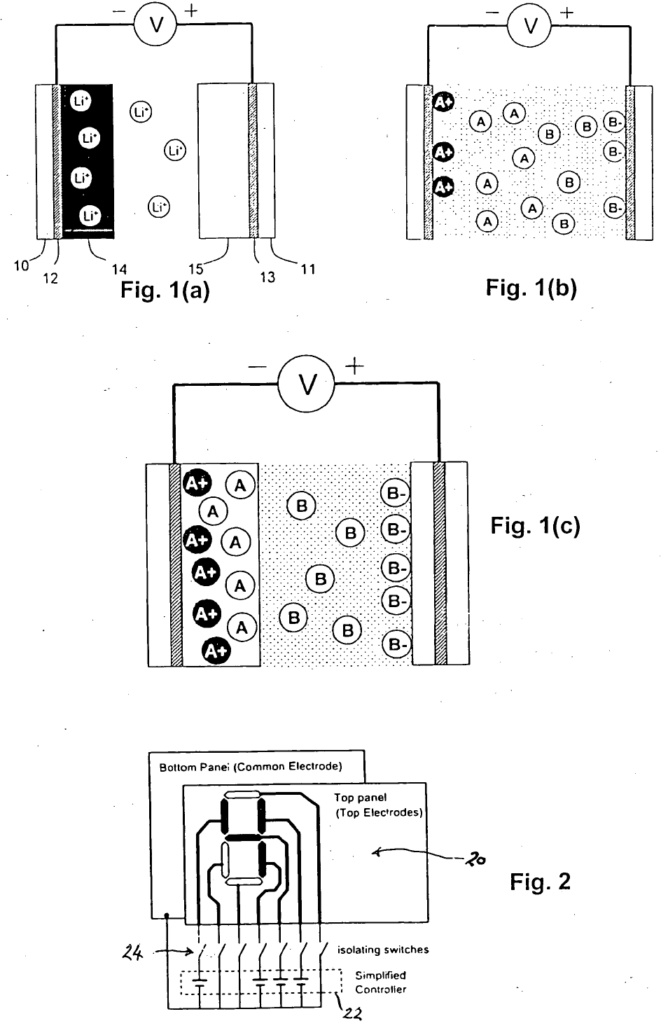

### DETAILED DESCRIPTION OF EMBODIMENTS OF THE INVENTION

An embodiment of an electro-optical arrangement in accordance with the invention is shown in FIG. 5. In FIG. 5 the display area 50 comprises an active-matrix electrochromic display driving scheme using low-temperature polysilicon thin-film transistor technology (LTPS-TFT).

The electrochromic pixel elements 51 are connected such that all working electrodes are connected to individual select transistors 52. The working electrodes are shown by the shorter rectangular box, which indicates negative polarity. These electrodes are responsible for the coloration that occurs when the pixel elements are driven into their light-modulated, as opposed to cleared (transparent), state.

The display area 50 is driven by line-select signals (Vsel) 53 provided by an external controller 54 and by data signals (Vdata) 55 likewise provided by the external controller 54. The line-select signals (Vsel) and data signals (Vdata) are fed into respective shift registers 56, 57 and the parallel output of shift register 57 is latched in a latch 58 and supplied to the TFTs 52 by way of a buffer 59. Thus the data signals 55 for one line of the matrix or array are output in series by the controller 54 to the shift register 57 and are subsequently output in parallel by the shift register 57 to the buffer 59. The buffer 59 passes on the latched data signals as signals Vdat to the individual TFTs 52 and ensures that sufficient current is available to drive the pixel elements 51 when they are turned on.

Although the counter-electrodes of the elements 51 (longer rectangular box, indicating positive polarity) are shown as individual electrodes in FIG. 5, in practice they are realized as a continuous electrode Vcom shared by all the pixels on the back panel.

The drive signals as seen by the pixels 51 and associated driver TFTs 52 are illustrated in a waveform diagram included as FIG. 6(b).

As a first operation following the powering-up of the display, rows of the pixel elements are placed into their cleared state. This is done in the example shown by placing an approximately equal voltage on the element electrodes. Hence the voltage difference across these electrodes is nominally zero. FIG. 6(a) shows this operation as the application of zero volts on the two electrodes of the pixel elements of a particular row, though other equal voltages could be used. Alternatively, in some devices, depending on the materials used, the device can also be cleared by making Vdat lower than Vcom.

In the example shown, following power-up the signals Vcom and Vdat are at zero volts ready for the application of a select voltage, Vsel, to a particular row. Application of Vsel clears all the pixel elements in that row. Vsel is then removed and a particular potential 60 is applied to Vcom ready for the writing of the data to the pixel elements of that row. Following the raising of the voltage level of signal Vcom, the data signals for that row from the latch 58 are provided by the buffer 59 to the TFTs 52. This occurs during time period 61. Time period 61 is set to allow sufficient time for the ECD to go fully into its coloration (light-modulated) state and may be of the order of 10 minutes. In practice, the various data signals Vdat for the pixels in the row in question may have voltages greater than or less than Vcom, depending on which of two coloration states the various pixels are to assume. These states may, again depending on the materials used, represent two different colors to be displayed, or a particular color (Vdat>Vcom) for one state and—as already mentioned—the cleared (transparent) condition (Vdat<Vcom) for the other state. This situation is shown in FIG. 6(a), where for a write cycle Vdat may take either of two values 62 and 63, while Vcom takes a value 64 intermediate these two values. The voltage difference between potentials 62 and 64 and between potentials 63 and 64 is less than or equal to a safe operating voltage determined beforehand for the particular ECDs being used. This safe operating voltage is sufficiently below a breakdown voltage associated with the ECDs to enhance reliability and to allow for supply voltage fluctuations, while at the same time reducing the current consumption in the driver electronics.

Shortly after the data signals (Vdat) have appeared on the device data lines, Vsel goes high again so that the TFT drivers for the row in question are switched on, thereby allowing the various values of Vdat to pass through to the individual pixel elements.

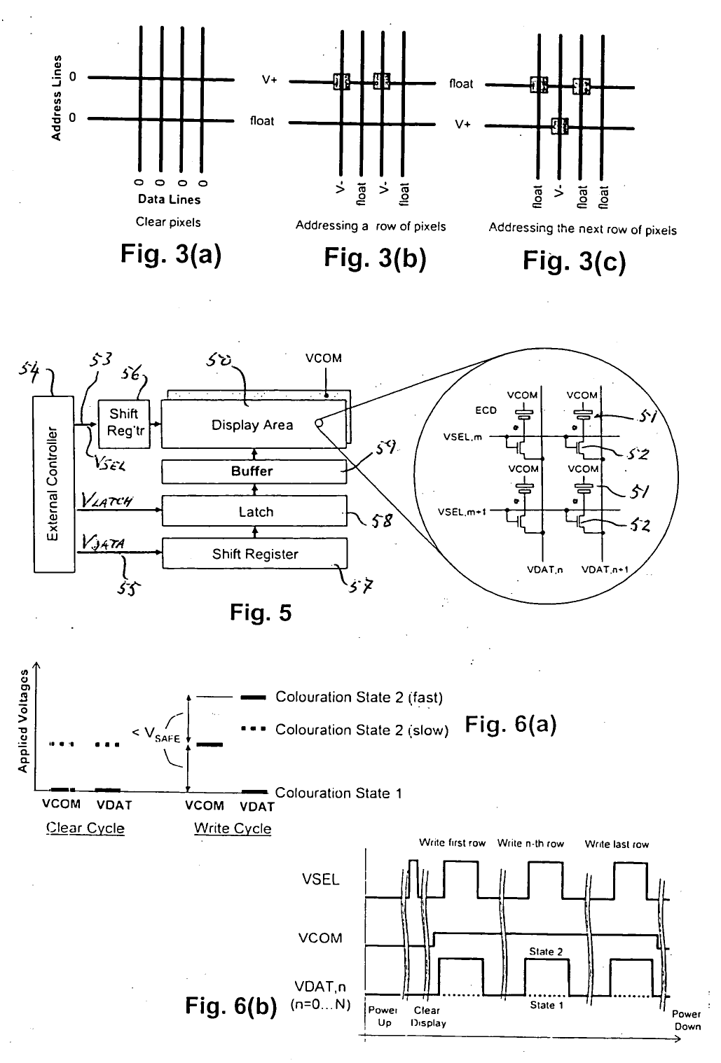

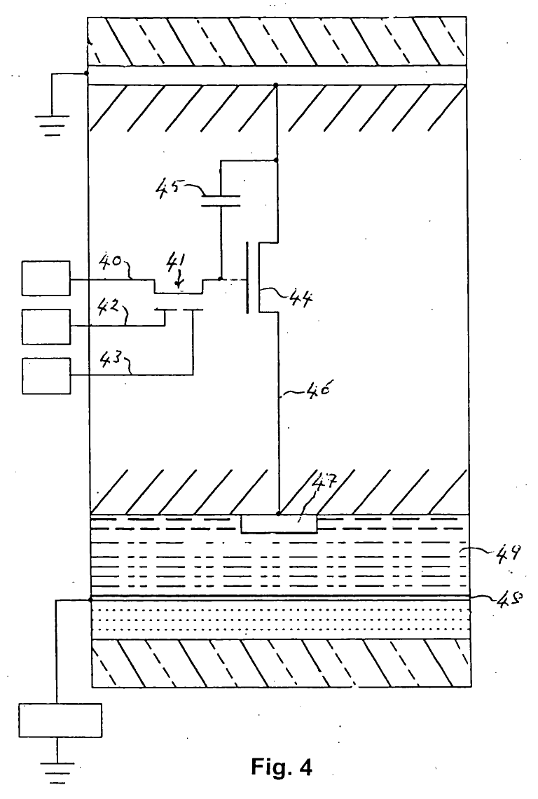

Shortly before the end of the write period 61 Vsel is once again removed, following which, signals Vdat are also removed. The state of each of the pixels in that row is retained by allowing Vsel and Vdat for those pixels to float (that is, the row-select and data lines are disconnected from their power sources—see FIGS. 3(a)-3(c)), while the same process is repeated for the next line of pixel elements, and so on for the whole display. The end result is a display in which all of the pixels are in their desired state, cleared or colored or with either of two different colors (coloration states). Finally, the display is powered-down and these pixel states persist until the display is again powered up and cleared in order to allow a different image to be displayed. The persistence of the image may typically be of the order of days.

Incidentally, FIG. 6(a) also shows the Vcom and Vdat lines for a clear cycle. The full lines shown as zero volts are the preferred way of driving these lines during the clear cycle, but—as already mentioned—it is possible to take these lines to other, nominally equal voltages (shown by the dotted lines in FIG. 6(a)) or Vdat may with some devices be made lower than Vcom to clear the display.

To clear the display, either Vsel may be applied to one row only at a time, so that, for the display to be completely cleared, a series of Vsel pulses will be required, or Vsel may be applied to all the rows simultaneously, in which case the clearing operation will apply to all the pixels simultaneously.

The buffer 59 is a TFT buffer, which includes a polysilicon TFT buffer stage for each of the pixels in a row. Each of these stages serves all the pixels in a respective column of pixels. TFTs are employed, since they have a current-supplying capability sufficient for the reliable driving of the ECDs. They also have the advantage that they can be produced by processes compatible with the ECD manufacturing processes. However, a problem associated with the use of polysilicon TFTs in this context is that they may have a minimum output voltage which is greater than the maximum voltage that can be tolerated across the ECDs (the ECD breakdown voltage). A typical TFT-stage minimum output voltage (which may correspond to a threshold-voltage value (V_{TH}) of the stage) is, for example, 2.5V, though devices vary in this respect and may have minimum output voltages less than or greater than this (e.g. >5V). The drive arrangement just described solves this problem by raising Vcom to, for example, midway between the Vdat values for the two display states. Thus, if Vcom is placed at about 1.25V, Vdat can take the values 0V or 2.5V for the respective display states without endangering the ECDs, since the drive voltage 1.25V is less than the irreversible breakdown voltage of 1.4V, which is an exemplary breakdown-voltage value for an ECD device. In practice, the invention strives to keep the voltages across the ECD device to below a safe operating voltage (V_{safe}), which is less than the breakdown voltage for that device.

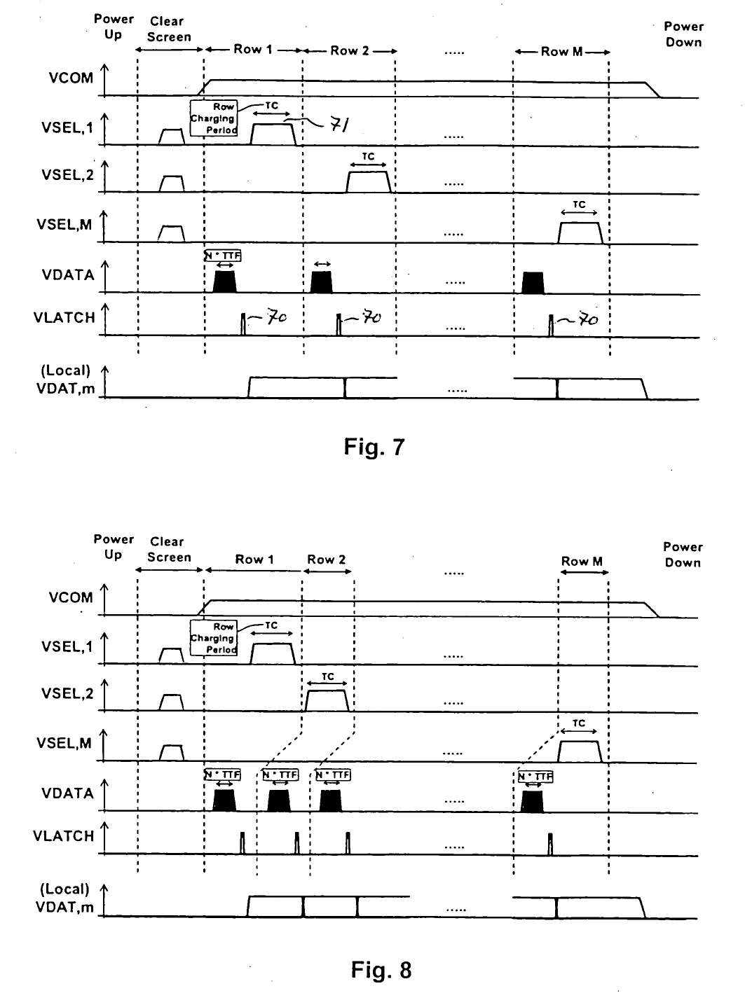

The pixel driving procedure from the point of view of the external controller is illustrated in FIG. 7. FIG. 7 shows as ordinates the common signal Vcom, the selection signals (Vsel) for M rows, the data signals Vdata, the latching signal Vlatch and the data signals Vdat local to the pixel elements. The abscissa is time.

The following steps are performed:

Firstly, the display is connected to the controller without the application of power. Secondly, power is applied in a power-up step. Thirdly, signal Vsel is applied to all the rows simultaneously with Vdata at zero volts and Vcom at zero volts. By this means all the pixel elements of the display are placed into their cleared state. Fourthly, the pixel elements of rows 1-M are written to in row order. This involves the data signals Vdata for a particular row being clocked into the shift register 57, following which these data are latched by a latching signal 70 and made available to the various TFT drivers 52 of that row as Vdat on their data lines. Then Vsel for that row is applied as signal 71, whereby the data signals Vdat either place the respective pixel elements into their light-modulated state (colored) or maintain the existing cleared state. At the end of time TC, which is the time required to fully charge the row of pixel elements, the relevant Vsel signal goes low and the pixel elements retain their current states. The latched data signals Vdat are retained while shift register 57 receives the data information Vdata for the next row of pixel elements. When all the data information has been written to the shift register, latching signal 70 is applied again to latch this new information onto the data lines of the driver TFTs of this new row as new data Vdat. Then Vsel for this row goes high for time TC, and so on for all the rows in the display in sequence. Once all the rows have been written to, the display is powered down and disconnected from the controller. The display, as already mentioned earlier, then retains its display information without the application of power.

If there are N pixel elements per row and M rows in the display, and if the time required to transfer Vdata from the external controller 54 to the shift register is TTF and, as already mentioned, the time required to charge a line of pixels fully is TC, then the total time required to write a monochrome display with all its image data is:
M*(N*TTF+TC)

This driving scheme is simple, but it takes a long time when the display is large and when TC is also large. A quicker scheme is illustrated in FIG. 8. The difference between this scheme and that of FIG. 7 is that the data Vdata for a row are loaded into the shift register 57 during time TC—that is, while the previous row's data are being assimilated by the display. This effectively saves time N*TTF for each row of the display. For this scheme to be practicable, the following relationship must obtain between the charging time TC and the row data transfer time N*TTF:
TC≧N*TTF.

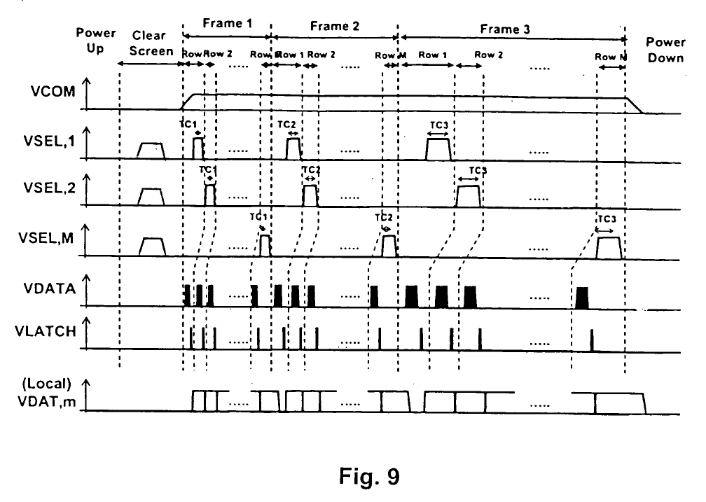

The invention also envisages the use of greyscale control in an ECD display. FIG. 9 shows a scheme for achieving this, in which the total time for charging the display is divided into three “frames”, or “write periods”. Loading of the shift register 57 with data Vdata and latching of these data are carried out for each row of the display as already explained in connection with FIGS. 7 and 8. In the case of the first frame, the length of time during which the pixel elements of each row are charged with the respective row data is TC1. In the second frame loading of the shift register 57 and latching by the latch 58 take place again, but this time the charging time for the latched data Vdat is TC2, which is greater than TC1. Finally, the process is repeated for a charging time TC3 greater than TC2. There is thus created a three-bit greyscale in which the coloration intensity of each pixel is determined in accordance with whether or not each pixel is allowed to continue to charge over successive frames. Thus each frame constitutes a “bit” in the greyscale.

In the general case, where there are M frames, the charging-time weighting of the various frames may, in one form, be expressed as:
TCn=R(n)*TC₀
where n=0, 1, 2 . . . M-1, R(n) is a correction function and TC₀ is a minimum charging period, which will normally apply to the first frame. In a preferred embodiment R(n)=2ⁿ, that is, the various charging periods TC1, TC2, TC3, etc, follow a binary sequence, so that TC2=2*TC1, TC3=2*TC2, and so on. This has the advantage of least complexity for the controller design. Other weighting arrangements are possible, however. For example, for a linear weighting the charging times may be expressed as:
TCn=(nk+1)TC₀
where k is a constant, n=0, 1, 2 . . . M-1.

The above-described frame-based scheme is not related to the display of a moving image, which might normally be implied by the use of the term “frame”. In the present case the image for all of the frames is the same. All that is being changed in each frame is the amount of charge allowed into the individual pixel elements of each row. Thus the image is a still image, which is assumed to be the case in the previous embodiments of the invention as well.

To refine the resolution of the greyscale, recourse would be had to a greater number of frames than just three.

To achieve the correct greyscale data for each pixel in a row, the external controller 54 is arranged to output the appropriate data signals for either clear or colored (or two different colors) for appropriate ones of the frames in accordance with the binary value required. As an example, Table 1 below lists the data output for a row of ten pixel elements over the three frames for a greyscale display of 2, 4, 1, 0, 5, 7, 7, 6, 3, 0 (out of a scale of from 0 to 7) over that row.

TABLE 1

| | Vdata for Pixels 0-9 (C = colored, 0 = clear, F = float) | | | | | | | | | |
|---|---|---|---|---|---|---|---|---|---|---|
| Frame | 0 | 1 | 2 | 3 | 4 | 5 | 6 | 7 | 8 | 9 |
| 1 (2⁰) | 0 | 0 | C | 0 | C | C | C | 0 | C | 0 |
| 2 (2¹) | C | 0 | F | 0 | F | C | C | C | C | 0 |
| 3 (2²) | F | C | F | 0 | C | C | C | C | F | 0 |

Vdata takes the appropriate voltage values for “colored” or “clear”, or allows Vdat to float so that the state for the previous frame is not disturbed.

An alternative way of achieving greyscale drive is to apply a reduced voltage Vdat to the ECD devices relative to Vcom during non-active frames. This situation is shown in FIG. 6(a), in which the normal value of Vdat for a coloration state 2 is shown as a continuous black line, while the reduced value is shown as an interrupted line. The higher voltage shown as a continuous line will provide a fast color change, while the lower voltage shown as the interrupted line will provide a slower change. Consequently it is possible to dispense with the floating state (state “F” in Table 1) on the data lines and instead simply continue the previous normal (high) “colored” drive voltage “C_{H}” as a “slow” (low) drive voltage“C_{L}” for the relevant frames. Strictly speaking, this approach will mean that, when the color change process should be suspended during the inactive frames, it will actually be continuing in the same direction, but at a much slower rate. Depending on the rate, this continued change may be small enough to be negligible.

This alternative greyscale drive scenario is set out in Table 2 below.

TABLE 2

| | Vdata for Pixels 0-9 (C_{H} = colored (high), | | | | | | | | | |
|---|---|---|---|---|---|---|---|---|---|---|
| | C_{L} = colored (low), 0 = clear) | | | | | | | | | |
| Frame | 0 | 1 | 2 | 3 | 4 | 5 | 6 | 7 | 8 | 9 |
| 1 (2⁰) | 0 | 0 | C_{H} | 0 | C_{H} | C_{H} | C_{H} | 0 | C_{H} | 0 |
| 2 (2¹) | C_{H} | 0 | C_{L} | 0 | C_{L} | C_{H} | C_{H} | C_{H} | C_{H} | 0 |
| 3 (2²) | C_{L} | C_{H} | C_{L} | 0 | C_{H} | C_{H} | C_{H} | C_{H} | C_{L} | 0 |

One possible drawback of this alternative greyscale drive scheme is that it is necessary for the buffer to have any of three drive states: clear (“0”), colored high (“C_{H}”) and colored low (“C_{L}”). In a further variant scheme the clear state (“0”) is replaced by colored low (“C_{L}”). This has the advantage of reducing the complexity of the buffer design to just two states instead of three. This scheme is set out below as Table 3.

TABLE 3

| | Vdata for Pixels 0-9 (C_{H} = colored (high), | | | | | | | | | |
|---|---|---|---|---|---|---|---|---|---|---|
| | C_{L} = colored (low)) | | | | | | | | | |
| Frame | 0 | 1 | 2 | 3 | 4 | 5 | 6 | 7 | 8 | 9 |
| 1 (2⁰) | C_{L} | C_{L} | C_{H} | C_{L} | C_{H} | C_{H} | C_{H} | C_{L} | C_{H} | C_{L} |
| 2 (2¹) | C_{H} | C_{L} | C_{L} | C_{L} | C_{L} | C_{H} | C_{H} | C_{H} | C_{H} | C_{L} |
| 3 (2²) | C_{L} | C_{H} | C_{L} | C_{L} | C_{H} | C_{H} | C_{H} | C_{H} | C_{L} | C_{L} |

It is assumed with all three versions of the greyscale driving scheme just described that the display will be cleared initially by the application of all “0” s as the drive signal.

To implement the greyscale scheme, it is preferred to realize the buffer 59 as a constant-current source with its output voltage limited to prevent the ECD from exceeding its Vmax limit. In this case controlling the length of time during which this current is being applied to the various pixel elements governs the amount of charge introduced into these elements in a linear fashion.

Although the invention has been described in connection with an active-matrix ECD display, it can also be implemented in a direct-driving or passive-matrix type ECD display.

Where an active matrix drive is used, this is not limited to a TFT-type drive, but may instead be based on CMOS devices, for example.

Whereas FIG. 9 shows a scheme in which the successive charging times in a greyscale driving arrangement successively increase in value, it is equally conceivable that the charging times will decrease in value. This applies whatever the relationship between charging-time change and time—e.g., whether the relationship is binary or linear.

1. An electro-optical arrangement, comprising:
an electrochromic device capable of being selectively placed into a first display state and a second display state, the device having first and second electrodes and a predetermined safe operating voltage value, V_{safe}, of a voltage to be applied across the first and second electrodes; and
a driver stage for providing a first electrode-drive signal to drive said first electrode and a second electrode-drive signal to drive said second electrode, the driver stage comprising a polysilicon thin-film transistor buffer for receiving a drive signal from an external controller and for supplying this drive signal as a buffered second electrode-drive signal to the electrochromic device, the driver stage being configured such that, to drive the device into its first display state, it applies as the first electrode-drive signal a first voltage V₁ and as the second electrode-drive signal a second voltage V₂, and to drive the device into its second display state, it applies as the first electrode-drive signal a third voltage V₃ and as the second electrode-drive signal a fourth voltage V₄,
wherein:
V₂>V₁
V₃>V₄

|V₁-V₂|≦V_{safe}, and

|V₃-V₄|≦V_{safe.}

2. Arrangement as claimed in claim 1, wherein V₁=V₃.

3. Arrangement as claimed in claim 2, comprising a two-dimensional array of the electro-optical devices, the buffer comprising a plurality of polysilicon thin-film transistor drive elements, one for each of the electrochromic devices in a row, and wherein the driver stage comprises a shift register and a latch interposed between the external controller and the buffer stage, whereby drive signals (Vdata) from the external controller for a row of the electrochromic devices can be serially loaded into the shift register, latched and passed on as the second electrode-drive signals (Vdat) to a row of electro-optical devices by way of the buffer.

4. Arrangement as claimed in claim 3, wherein:
V1=V3½(V2-V4)

5. Arrangement as claimed in claim 3, wherein the driver stage is configured such that, while the latched drive signals (Vdata) are being applied to one row of the array, the drive signals (Vdata) for the next row are loaded into the shift register.

6. Arrangement as claimed in claim 4, wherein the buffer is arranged to provide a constant-current output and the driver stage is arranged to write data signals to the electrochromic devices in a series of successive write operations, the intensity of coloration in selected ones of the electrochromic devices being changed successively in one or more of the write operations until the desired coloration intensity for each of the selected electrochromic devices is achieved.

7. Arrangement as claimed in claim 6, wherein the successive write operations are arranged to achieve different additional coloration intensities.

8. Arrangement as claimed in claim 7, wherein the successive write operations are arranged to achieve additional coloration intensities which increase or decrease in a binary series.

9. Arrangement as claimed in claim 6, wherein the second electrode-drive signal, during frames in which there is to be no increase in coloration intensity, assumes a floating state.

10. Arrangement as claimed in claim 6, wherein the second electrode-drive signal, during frames in which there is to be no increase in coloration intensity, assumes a second voltage value V₂ which is lower than the second voltage value V₂ which is assumed during frames in which there is to be an increase in coloration intensity.

11. Arrangement as claimed in claim 10, wherein the safe voltage value, V_{safe}, is approximately 1.4V, the second voltage, V₂, is approximately 2.5V maximum, the fourth voltage, V₄, is approximately 0V and the first voltage, V₁, and the third voltage, V₃, are approximately 1.25V maximum.

12. Arrangement as claimed in claim 10, wherein the driver stage is configured to apply, before the application of the first, second, third and fourth voltages, V₁-V₄, fifth and sixth voltages, V₅ and V₆, to the first and second electrodes, respectively, in order to place the electrochromic device into an initial clear state, wherein V5≈V6.

13. Arrangement as claimed in claim 12, wherein V5=V6=0 v.

14. Arrangement as claimed in claim 10, wherein the first display state is a first coloration state, in which the electrochromic device displays a first color, and the second display state is a second coloration state, in which the electrochromic device displays a second color.

15. Arrangement as claimed in claim 10, wherein the first display state is a coloration state, in which the electrochromic device displays a given color, and the second display state is a clear state, in which the electrochromic device is transparent.

16. Method for driving an electrochromic device capable of being selectively placed into a first display state and a second display state, the device having first and second electrodes and a predetermined safe operating voltage value, V_{safe}, of a voltage to be applied across the first and second electrodes, the method comprising:
applying a first voltage less than the safe operating voltage across the first and second electrodes in one direction to place the device into the first display state, or applying a second voltage less than the safe operating voltage across the first and second electrodes in the opposite direction to place the device into the second display state, the first and/or second voltage being applied by way of a polysilicon thin-film transistor buffer.

17. Method according to claim 16, wherein the first display state is a cleared state.

18. Method according to claim 17, wherein the first voltage is approximately zero volts.

19. Method according to claim 16, wherein the electrochromic device is one of a plurality of such electrochromic devices arranged in a two-dimensional array, and drive signals (Vdata) for the electrodes of a row of the electrochromic devices are serially loaded into a shift register, latched and then passed on by way of the polysilicon thin-film transistor buffer to the row of electro-optical devices.

20. Method according to claim 19, wherein, while the latched drive signals (Vdata) are being applied to one row of the array, the drive signals (Vdata) for the next row are loaded into the shift register.

21. Method according to claim 19, wherein the buffer provides a constant current output and the driver stage writes data signals to the electro-optical devices in a series of successive write operations, the intensity of coloration in selected ones of the electrochromic devices being changed successively in one or more of the write operations until the desired coloration intensity for each of the selected electrochromic devices is achieved.

22. Method as claimed in claim 21, wherein the successive write operations achieve different additional coloration intensities.

23. Method as claimed in claim 22, wherein the successive write operations achieve additional coloration intensities which increase or decrease in a binary series.

24. Method as claimed in claim 19, wherein the buffer applies a voltage (Vdat) of a first value to the first electrode to achieve the first display state or applies a voltage (Vdat) of a second value to the first electrode to achieve the second display state, and a voltage of a third value intermediate the first and second voltage values is applied to the second electrode.

25. Method as claimed in claim 24, wherein the third voltage value lies approximately midway between the first and second voltage values.

26. Method as claimed in claim 25, wherein the buffer comprises a plurality of polysilicon thin-film transistor stages for respective electrochromic devices in a row, the thin-film transistor stages being associated with a threshold-voltage value for those stages, and wherein said second voltage value is higher than said first voltage value by said threshold-voltage value.

27. Method as claimed in claim 16, wherein the first and second display states are first and second coloration states, respectively, in which the electrochromic device displays different colors.
